(19) United States
(12) Patent Application Publication
(10) Pub. No.: US 2010/0053745 A1
(43) Pub. Date: Mar. 4, 2010

(54) VIDEO ADAPTER FOR A MICROSCOPE CAMERA

(75) Inventor: Ulrich Sander, Rebstein (CH)

Correspondence Address: ALEXANDER R SCHLEE;SCHLEE IP INTERNATIONAL P.C., 3770 HIGHLAND AVENUE, SUITE 203, MANHATTAN BEACH, CA, 90266, US

(73) Assignee: LEICA MICROSYSTEMS (SCHWEIZ) AG, Heerbrugg (CH)

(21) Appl. No.: 12/554,629

(22) Filed: Sep. 4, 2009

(30) Foreign Application Priority Data
Sep. 4, 2008 (DE) 102008041821.8

(51) Int. Cl. G02B 21/06; G02B 21/36; H04N 7/18

(52) U.S. Cl. 359/389; 396/544; 348/79

(57) ABSTRACT

A video adapter for a microscope is described, comprising a first connection for connecting the microscope; a second connection for connecting a camera; and at least one optical component for performing at least one of exposure setting, focus setting, magnification setting and deflection of at least one part of an observation beam path of the microscope into an image plane of the camera. The at least one optical component has an SLM optical unit. Further, a system is described comprising the aforementioned video adapter, a microscope, and a camera.

### CROSS-REFERENCE TO RELATED APPLICATION

This application claims the priority of the German patent application DE 102008041821.8 having a filing date of Sep. 4, 2008. The entire content of this prior German patent application DE 102008041821.8 is herewith incorporated by reference.

### BACKGROUND OF THE INVENTION

The present invention relates to a video adapter for a microscope having a connection for the microscope and a further connection for a camera, wherein the video adapter has at least one first optical component for exposure setting, for focus and/or magnification setting and/or for deflection of at least one part of an observation beam path of the microscope into an image plane of the camera, and to a microscope, in particular a stereomicroscope, comprising such a video adapter. The term “connection” is intended to encompass not only releasable connections but also fixed connections.

Video adapters for microscope cameras are known for example from U.S. Pat. No. 6,056,409 and EP 1 216 431 B1, both of which are concerned with video adapters that are essentially constructed identically. A video adapter connects a video camera to a microscope. The term video cameras encompasses both digital and analogue motion picture or still image cameras. CCD (Charge Coupled Devices) cameras are often used. The microscope can be, in principle, any microscope, in particular a stereomicroscope or surgical microscope. By connecting a camera to such a microscope, it is possible for example to document an examination procedure. In the case of surgical microscopes, in particular, it is possible in this way for interventions not only to be documented but also to be followed in real time. In particular, the remote transmission of the camera images to locations away from the examination or intervention location is also possible (remote diagnoses, remote operations).

Various models of photographic and camera adapters, their areas of use, technical data in respect thereof and representations of the beam courses can be found in “ZEISS Microscopes for Microsurgery”, Springer-Verlag, 1981, edited by W. H. Lang and F. Muchel, pp. 86-96. This document represents the known beam course in a stereomicroscope, wherein, in a parallel beam section between magnification changer and binocular tube, a beam splitter is arranged at least in one of the two channels of the stereomicroscope. The beam splitter deflects part of the observation beam path to the documentation port of the stereomicroscope. A video adapter, designated therein as photographic, film or TV adapter, is connected to the documentation port of the microscope. The construction of the various adapters mentioned is similar, and the various adapters are therefore intended to be combined under the term “video adapter” in the present application. Since a parallel beam path is coupled out, each video adapter has to be provided with a converging optical unit in order to generate an image in the image plane of the cameras. The beam path is usually directed in the direction of the camera by means of a deflection mirror. Adapters for film cameras are additionally equipped with an adjustable diaphragm (iris diaphragm). The driving can be effected manually or—as already mentioned above—in motor-controlled fashion. The (automatic) diaphragm control is highly important for ensuring optimum exposures in the camera for different illumination conditions of the working field (object region) and for different magnification settings on the microscope. The abovementioned optical components of the video adapter, namely converging optical unit or zoom system, deflection mirror and iris diaphragm, are also described in greater detail in terms of the construction and function in the cited documents U.S. Pat. No. 6,056,409 and EP 1 216 431 B1, to which reference shall expressly be made at this juncture.

On account of the position of the examined region or on account of movements of the examined object, for instance in the case of interventions on the eye, brain or ear of a patient, but also in the case of industrial applications such as wafer inspection, the region to be examined often does not lie in the centre or in the field of view of the camera. Consequently, there is a need for readjustment without moving the microscope itself. The same applies to the case where the region to be examined is imaged unsharply by the camera. In the case of operations, it is generally not reasonable for the surgeon or assistant to perform such readjustments on the video adapter. Therefore, there is a need to be able to perform such readjustments largely automatically.

For this purpose, the cited document EP 1 216 431 B1 proposes a video adapter with which the abovementioned readjustments can be performed by an operator in a motor-controlled manner, whereby the camera image can be controlled remotely. The video adapter proposed therein has, proceeding from the connection to the microscope, an iris diaphragm, a zoom system and a deflection mirror, which deflects the observation beam by 90° into the connection piece for the camera. For automatic adjustment, the video adapter has a first motor for driving the iris diaphragm, a second motor for focus control and a third and fourth motor for moving the deflection mirror. By means of these two last-mentioned motors, the deflection mirror can be moved about two mutually perpendicular axes, such that the image on the deflection mirror, which represents the microscope image, can be rotated in any desired directions, such that a specific image excerpt can be directed to a specific location of the image plane of the camera. In this way it is possible to compensate for inclinations or movements of the object. By means of the second motor mentioned, it is possible to displace a cylinder accommodating the zoom system within the video adapter along the optical axis in order to control the focussing. In addition, the zoom system itself is manually and/or automatically adjustable in terms of its magnification.

This known motor-based video adapter described has at least two motors for adjusting the deflection mirror. Further motors are provided for controlling the function of an iris diaphragm and for controlling the focussing and the zoom adjustment. The motors mentioned necessitate corresponding mechanical gear mechanisms, a correspondingly large structural volume, a correspondingly large weight and extensive electronics for motor control. In practice this proves to be technically complex and hence disadvantageous. Furthermore, it is necessary to implement measures for reducing the evolution of noise and vibrations, measures which are likewise complex and often not carefully targeted.

In a different context, DE 103 49 293 A1 discloses stereomicroscopy systems having changeable optical properties. This document proposes using an objective comprising a first lens having a positive refractive power, a second lens having a negative refractive power and a third lens having a changeable refractive power for the changeability of the working distance of the stereomicroscopy system. The lenses having a liquid crystal layer which can be driven by means of an electrode structure are proposed as lenses having a changeable refractive power. Furthermore, this document proposes the use of a lens having an adjustable refractive power for the two zoom optical units in the left and right stereo channels of the stereomicroscopy system in order to provide a changeable magnification of the stereomicroscopy system without having to move lens assemblies of the zoom optical unit along the principal axis of the zoom optical unit for this purpose. Finally, this document also proposes the use of such lenses having a changeable refractive power for an eyepiece of a stereomicroscopy system. In addition to the abovementioned liquid crystal lens having a changeable refractive power, a pure liquid lens comprising two immiscible liquids having different refractive indices and two electrodes is also proposed, wherein the angle between the interface of the two liquids and the wall surrounding the latter can be altered by changing the voltage between the electrodes. A change in this angle leads to a change in the lens effect of the liquid lens. The optical components, objective, zoom optical unit and eyepiece, mentioned in said document have at least one lens assembly comprising a first lens having a positive refractive power, a second lens having a negative refractive power, and a third lens having an adjustable refractive power. By this means, although focus and magnification changes can be achieved without having to provide movable lens assemblies, at the same time the number of components of an optical component is increased, which results not only in increased optical calculation complexity and increased costs but also in larger structural volumes.

In yet another context, U.S. Pat. No. 6,377,397 B1 discloses the use of electro-optical layers (for example liquid crystal displays, LCD) arranged between two deflection prisms, by which the reflectance of the prism arrangement for impinging light beams can be set in an electronically controllable manner. In a similar manner, in accordance with EP 1 235 093 A2, a spectral filter, which can be configured as an LCD, can be used to perform an intensity- and/or wavelength-dependent reduction of the illumination intensity on an object, for example in a surgical microscope.

In yet another context, DE 101 16 723 C1 discloses in a general form an array comprising mirror elements for deflecting optical beams, wherein said array can be embodied for example as an optical imaging system (concave mirror) in order to replace heavy and large lenses.

Furthermore US 2005/0225884 A1 discloses a three-dimensional imaging device comprising a micromirror array lens, by means of which a two-dimensional image can be generated from a specific object plane of an object. By correspondingly setting the micromirror array lens, different focal planes of the object are successively imaged as two-dimensional images. The corresponding images are combined to form a three-dimensional image by means of image processing. For this purpose, the two-dimensional images are superimposed together with the depth information, resulting from the setting of the micromirror array lens, to form a three-dimensional image.

Finally, WO 2006/019570 A2 discloses a construction similar to that in the cited document US 2005/0225884 A1, wherein this construction is used as an autofocus system. An object is imaged onto a detector area by means of a lens. A micromirror array is disposed between lens and detector. If the object is no longer in focus, a blurred image arises on the detector, which leads to an alteration of the detector signal. By means of a corresponding control unit, the orientation of the micromirrors of the micromirror array can be correspondingly altered, such that the effective focal length of the imaging system can be tracked to the altered object position.

### SUMMARY OF THE INVENTION

It is an object of the present invention to specify a video adapter of the type mentioned in the introduction which can be realized in a technically less complex fashion and, in particular, avoids the disadvantages mentioned in the introduction.

This object is achieved according to the invention by means of a video adapter for a microscope, comprising: a first connection for connecting the microscope; a second connection for connecting a camera; and at least one optical component for performing at least one of exposure setting, focus setting, magnification setting and deflection of at least one part of an observation beam path of the microscope into an image plane of the camera, wherein the at least one optical component has an SLM optical unit.

The video adapter according to the invention has at least one SLM optical unit arranged in the beam path of the video adapter. Such SLM optical units which are known per se from the prior art, prove to be particularly advantageously usable in a video adapter. Surprising diverse advantages arise which have the effect that video adapters can be realized technically much more simply than heretofore and, in particular, in significantly smaller, lighter and more compact fashion and with significantly shorter response times and more precise driving.

In the present application, the term “SLM optical unit” is intended to be used as a collective term for optoelectronic elements which can influence the amplitude and/or phase of light wavefronts in a high-resolution manner. The abbreviation “SLM” stands for “Spatial Light Modulator”. This generally involves electronically driveable arrays (optically driveable SLMs also exist) which can be driven at each point of the array in order to change the impinging beam profile. A summary of SLM technology may be found for example in Sven Krüger et al., “Schaltbare diffraktiv-optische Elemente zur Steuerung von Laserlicht” [“Switchable Diffractive Optical Elements for Controlling Laser Light”], Photonik January 2004, page 46 et seq.

SLM optical units can also specifically be used for focussing and/or magnification. Liquid crystal optical units, such as liquid crystal lenses, having a variable, adjustable focal length are known (cf. Photonik May 2003, page 14, “Flüssigkristall-Optik” [“Liquid Crystal Optics”] and also optics & laser europe (OLE), May 2006, page 11, “Liquid Crystals ease bifocal stain”). One embodiment of such a liquid crystal lens comprises a liquid crystal layer between two glass layers, wherein the glass layers are coated with concentric transparent electrode rings. By changing a voltage applied to the electrode rings, these liquid crystal lenses vary their focal length. A further possibility is afforded by so-called “EAP lenses” (EAP=Elektroactive Polymer), in which the refractive power of the lens can be varied by applying an electrical voltage. Such elements are outstandingly suitable for wholly or partly replacing the conventional lenses present in a video adapter. Simple focus setting is made possible by this means. In the case of zoom systems, the use of SLM optical units can make displaceable zoom elements superfluous. Since the driving is effected electronically, it is additionally possible to dispense with previously conventional motors for displacing lens groups as a whole or relative to one another.

The SLM optical unit can be a reflective microdisplay, in particular a reflective liquid crystal display (LCD). Such reflective LCDs can be realized for example as LCoS light modulators (Liquid Crystal over Silicon). With regard to the construction and functioning of a reflective LCoS microdisplay, reference should be made to the cited article by Sven Krüger et al.

LCD systems have the advantage of small addressable structures, high resolution and high dynamic range. It is possible to realize amplitude and phase modulation with high precision and with short response times. Consequently, they can be used for beam shaping, beam splitting, dynamic aberration correction, etc. Besides the relatively new reflective LCDs, transmissive microdisplays (“electronic transparency”) such as transmissive liquid crystal displays, have been known for a relatively long time, and can likewise advantageously be used for the invention.

A further important representative of SLM optical units is micromirror arrays having individually drivable micromirrors which can be set in terms of their spatial orientation (DMD, Digital Micromirror Device). Such micromirror arrays can be used for beam deflection and beam splitting. If the micromirrors are suitably oriented in spherical or aspherical fashion (or more generally: in non-planar fashion) in terms of their orientation, then a micromirror array can also be used for focussing and/or for optical correction. With regard to the technical principles and possible uses, reference should be made to the article “DLP Technologie—nicht nur für Projektoren and Fernsehen” [“DLP Technology—not just for projectors and television”] in Photonik January 2005, pp. 32-35.

As set out below, the essential components of a conventional video adapter can be wholly or at least partly replaced by SLM optical units.

Conventional video adapters have a first optical component for exposure setting, a second optical component for focus and/or magnification setting, and a third optical component for deflection of the observation beam path into an image plane of the camera, As already explained, these optical components are generally an iris diaphragm, a converging lens assembly and/or a zoom system, and respectively a deflection mirror.

The deflection mirror (third optical component) which is regularly present in the video adapter and which directs the beam path in the video adapter onto an image plane of the camera can be embodied according to the invention as an SLM optical unit, in particular as a reflective microdisplay or as a micromirror array. The previous tilting of the deflection mirror about two mutually perpendicular (x-y) spatial axes in order for example to move examined object regions into the field of view or into the image centre of the camera can be replaced in this way for example by the corresponding tilting of micromirrors of a micromirror array. In this way, only the micromirrors change their orientation, while the baseplate carrying the micromirrors remains unchanged in its position. In this case, the driving of the mircromirrors is effected exclusively electronically, with the result that the previously conventional motors for moving the deflection mirror can be obviated. This also eliminates the corresponding space, weight and noise problems. Furthermore, the electronics are configured with greater clarity.

In a further advantageous configuration, the driveable (iris) diaphragm (first optical component) which is present in conventional video adapters and serves for the exposure control of the camera can be replaced by SLM optical units. Transmissive microdisplays, in particular, are suitable for this purpose. It is thereby possible to electronically control for example brightness, spectral intensity and depth of field of the beam course in the video adapter. A motor for driving an iris diaphragm is superfluous. This is in turn associated with the advantages already mentioned. Diaphragm form, position and (spectral) transmission of the transmissive SLM optical unit can be chosen in a suitable manner.

Finally, elements (second optical component) which are present in conventional video adapters and serve for focussing and/or magnification or zoom setting can also be replaced by SLM optical units.

It is conceivable, for example, for the SLM optical unit (for example micromirror array, that replaces the deflection mirror additionally to be utilized for focussing, by setting a suitable aspherical or spherical or more generally non-planar orientation of the micromirrors. When using a micromirror array or reflective microdisplay as a deflection mirror, it can additionally be used for brightness setting. On the other hand, it is also conceivable for the transmissive SLM optical unit that replaces the iris diaphragm additionally to be utilized for focussing. Moreover, optical corrections (aberration corrections), can additionally be performed in the cases mentioned.

The invention, by using SLM optical units in a video adapter, thus makes it possible, in particular, to combine functions which were distributed among different optical components in conventional video adapters. Furthermore, new functions (such as optical corrections) that could not be realized by the optical components previously available can be implemented.

One or a plurality of SLM optical units can perform one or a plurality of functions in the video adapter, which are selected from the group comprising: control of the brightness, control of the spectral intensity, control of the depth of field, control of the focussing, control of the magnification, beam deflection, beam splitting and optical correction of the beam course. In this case, two or more of the stated functions can be realized by a single SLM optical unit.

In a particularly preferred configuration, the SLM optical unit of an optical component of the video adapter has a micromirror array. This micromirror array can simultaneously fulfill a plurality of the stated functions: firstly, it serves for beam deflection, for example of at least one part of an observation beam path of the microscope into an image plane of the camera. At the same time, a focussing effect can be achieved by means of non-planar setting of the individual micromirrors, for example by means of spherical or aspherical configuration of the micromirror array. Finally, however, a micromirror array is also suitable for exposure setting, namely by setting individual micromirrors or a group of micromirrors in such a way that they do not reflect impinging light into the image plane of the camera, but rather for example to a different location, where in turn an absorber is situated, for example. Consequently, the micromirror array, within a specific dynamic range, can also be used for setting the exposure. Consequently, the micromirror array used in this way can in principle replace all three optical components previously used in the conventional video adapter, such as iris diaphragm, focussing element and deflection element.

In a further advantageous configuration, the SLM optical unit of an optical component of the video adapter according to the invention has a reflective microdisplay, which can likewise perform at least two of the stated functions: firstly, a reflective microdisplay is suitable for deflecting the observation beam path into the image plane of the camera; secondly, a diaphragm effect for exposure setting can be achieved by the targeted driving of regions of the microdisplay.

Finally, the SLM optical unit of an optical component of the video adapter according to the invention can have a transmissive microdisplay. In this case, the term “transmissive microdisplay” is intended to encompass the abovementioned liquid crystal lenses. Consequently, a transmissive microdisplay is suitable for performing a plurality of the abovementioned functions in the video adapter: the brightness, the spectral intensity, the depth of field, the focussing and the magnification can be controlled. Finally, an optical correction of the beam course can also be achieved within specific limits. Overall, a transmissive display can thus replace the first and second optical components present in conventional video adapters, such as iris diaphragm and focussing and/or magnification element.

The invention furthermore relates to a microscope system comprising a video adapter according to the invention and a microscope that can be connected thereto, wherein, in a further configuration, the microscope system has a camera that can be connected to the video adapter.

The incorporation of a video adapter according to the invention into such a microscope system leads to the already described advantages which, in particular, accompany the substantial omission of the motor driving systems of the video adapter and which are associated with the new possible functions of the SLM optical unit in the video adapter. In this respect, reference should be made to the explanations above.

A microscope system according to the invention comprises, in particular, a stereomicroscope having an objective (common main objective for at least two channels of the stereomicroscope or separate objectives per channel of the stereomicroscope), having magnification changers (discrete or continuous (zoom) systems) arranged in at least two of the channels of the stereomicroscope, and having an (optional) binocular tube, wherein a beam splitter for coupling out at least one part of the observation beam path to a documentation port of the stereomicroscope is arranged in at least one of the channels of the stereomicroscope, and furthermore a video adapter according to the invention having a connection for the microscope, which connection is connected to the documentation port of the stereomicroscope, and having a further connection for a camera. In this case, at least one optical component has an SLM optical unit. The latter can be, in particular, a reflective microdisplay or a micromirror array. By this means, as already explained above, the relevant optical component (in particular in the form of a micromirror array) can simultaneously perform, in addition to beam deflection, the function of focus setting, which was conventionally accorded to the second optical component, with the result that mechanical solutions to be correspondingly provided for the focus setting can be omitted. On the other hand, as likewise already explained above, the relevant optical component can also perform the function of exposure setting, with the result that the first optical component (in particular iris diaphragm) previously present in the video adapter can be obviated.

It should be pointed out that the various features of the invention outlined can be used not only in the combination presented here, but also in other combinations or by themselves, without departing from the scope of the present invention.

### BRIEF DESCRIPTION OF THE DRAWINGS

The invention and its advantages will be explained in greater detail below on the basis of an exemplary embodiment illustrated in the drawing.

FIG. 1 shows a known microscope system in cross section with a stereomicroscope and a video adapter.

FIG. 2 shows the construction of a known video adapter in cross section, and

FIG. 3 shows a video adapter in a particular embodiment according to the invention in cross section.

### DETAILED DESCRIPTION OF THE DRAWINGS

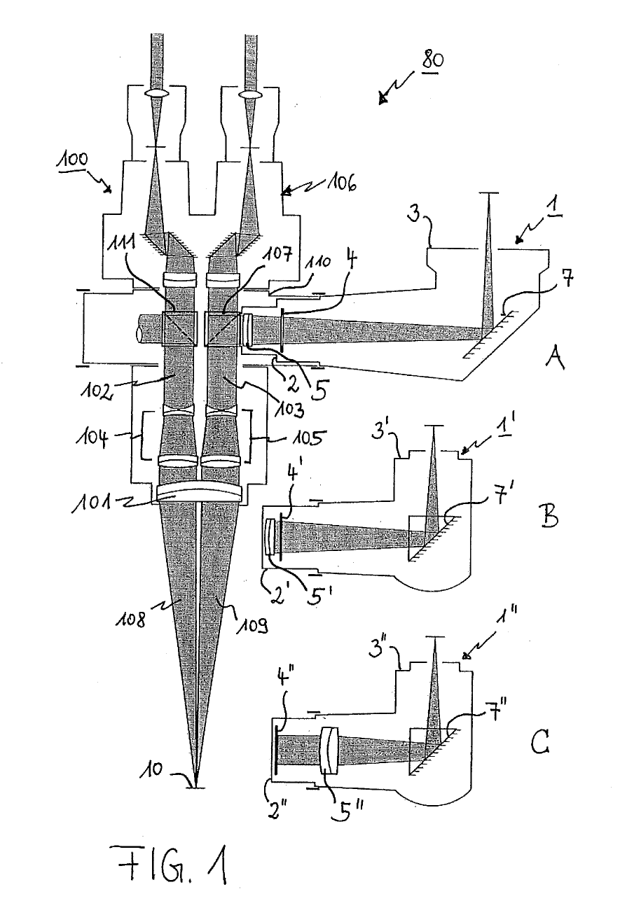

FIG. 1 shows a microscope system 80 with a stereomicroscope 100 and a video adapter 1. Further variants of the video adapter 1 are illustrated in the partial figures of FIGS. 1B and 1C. More detailed explanations concerning the construction and functioning of the microscope system 80 in accordance with FIG. 1 can be found in “ZEISS Microscopes for Microsurgery”, Springer-Verlag, 1981, edited by W. H. Lang and F. Muchel, pp. 86-96 to which reference shall explicitly be made here. Therefore, the text below is restricted to a rough overview.

In order to examine an object 10, the latter is viewed by means of a stereomicroscope 100, for example a surgical microscope, wherein the examination procedure, by means of the connection of a camera (not illustrated), can additionally be followed, transmitted and/or documented. In order to connect the camera to the microscope 100, a video adapter 1 having a connection 2 for the microscope 100 and a connection 3 for the camera is provided.

The stereomicroscope 100 is constructed in a known manner: light issuing from the object 10 reaches the channels of the magnification changers 104 and 105 via the common main objective 101 of the stereomicroscope 100 in the form of observation beam paths 108, 109. Said magnification changers 104 and 105 can be zoom systems, for example, which permit continuous magnification over a large magnification range. The illustration shows two channels 102, 103 of the stereomicroscope 100, wherein configurations having more channels, for example for assistant beam paths, additional documentation beam paths, etc., also exist. A beam splitter 107 is present in the channel 103 of the stereomicroscope 100, said beam splitter coupling out part of the observation beam path to a documentation port 110. In order that identical light conditions are present in the left and right channels 102, 103 of the stereomicroscope 100, a further beam splitter 111 can be provided in the left channel 102, said beam splitter coupling out the same part of the observation beam path 108 from the main beam path. The two main observation beam paths then reach a binocular tube 106 constructed in a known manner. The depicted construction of a stereomicroscope 100 permits the three-dimensional, highly magnified viewing of an object 10.

1 designates a video adapter, which can for example more specifically represent a photographic, film or TV adapter (cf. 1, 1′ and 1″ in partial figures A, B and C, respectively). Three optical components are common to all three types of video adapters 1, 1′, 1″: since a parallel beam path is coupled out from the channel 103 of the microscope 100, a (second) optical component 5, 5′, 5″ for focus setting is present in order to generate an image in the image plane of the camera. Furthermore a (first) optical component 4, 4′, 4″ for setting the exposure of the camera is present. Finally, a deflection element for deflecting the coupled-out (horizontal) beam path into the (vertical) axis of the camera or in the direction of the normal to the surface of the image plane of the camera is present as (third) optical component 7, 7′, 7″. The components 4, 4′, 4″ can be diaphragms, in particular iris diaphragms. The components, 5, 5′ and 5″ constitute lenses or lens assemblies. The components 7, 7′ and 7″ are deflection elements such as mirrors or prisms. The optical components 4, 4′ and 4″ for exposure setting are highly important particularly in the case of stereomicroscopes 100 having variable magnification, since a change in the magnification is also associated with a change in the brightness in the camera image. The optical components 4, 4′ and 4″ for exposure setting are correspondingly driven for the compensation of brightness changes.

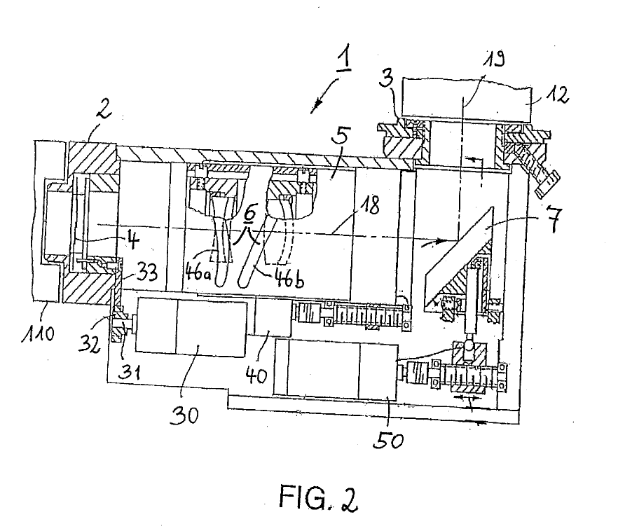

FIG. 2 shows a video adapter 1 in accordance with the prior art in cross section in detail. At this juncture, reference should explicitly be made to the document U.S. Pat. No. 6,056,409 already cited in the introductory part of the description, which document explains in detail the construction and the functioning of the video adapter 1 illustrated in FIG. 2. Therefore, the text below is restricted merely to presenting the basic principles.

The video adapter 1 illustrated in FIG. 2 has a connection 2 for a microscope, wherein said connection 2 can be connected to the documentation port 110 of the microscope. Proceeding from said connection 2, the video adapter 1 has a (first) optical component 4 for exposure setting, which is embodied here as an iris diaphragm. A motor 30 with corresponding gears and shafts and levers 31, 32, 33 controls the aperture of the iris diaphragm 4. In the direction of the axis 18 there follows an optical component 6 for magnification setting. This is a zoom system, which can be driven either manually by means of external handles 46a, 46b, or, more preferably, by motor. 5 designates the optical component for focus setting, which constitutes a barrel which is displaceable in the direction of the axis 18 and in which the zoom system 6 is accommodated. The axial displacement is effected by means of the motor 40 in this case. Following the axis 18 further, this is followed by the optical component 7 for deflecting the beam path into the image plane of the camera 12. The optical component 7 is embodied here as a simple mirror which can be rotated/pivoted about an x-axis by means of a motor 50 and about a y-axis perpendicular thereto by means of a further motor (not illustrated). Further details concerning the motor-based driving systems of the optical components 4 to 7 can be gathered from the cited document U.S. Pat. No. 6,056,409 (or EP 1 216 431 B1 corresponding thereto).

By means of the video adapter 1 illustrated in FIG. 2, the coupled-out image of an object 10 (cf. FIG. 1) can be directed onto an image plane of a camera 12, wherein the object image can be correspondingly oriented in the image plane of the camera 12 by means of an x-y movement of the mirror 7.

The known video adapter 1 in accordance with FIG. 2 already has four motors for driving the iris diaphragm 4, the component 5 for focus setting and the component 7 for beam deflection, and a further motor can be present for driving the zoom system 6. This is associated with the disadvantages already mentioned in the introductory part of the description.

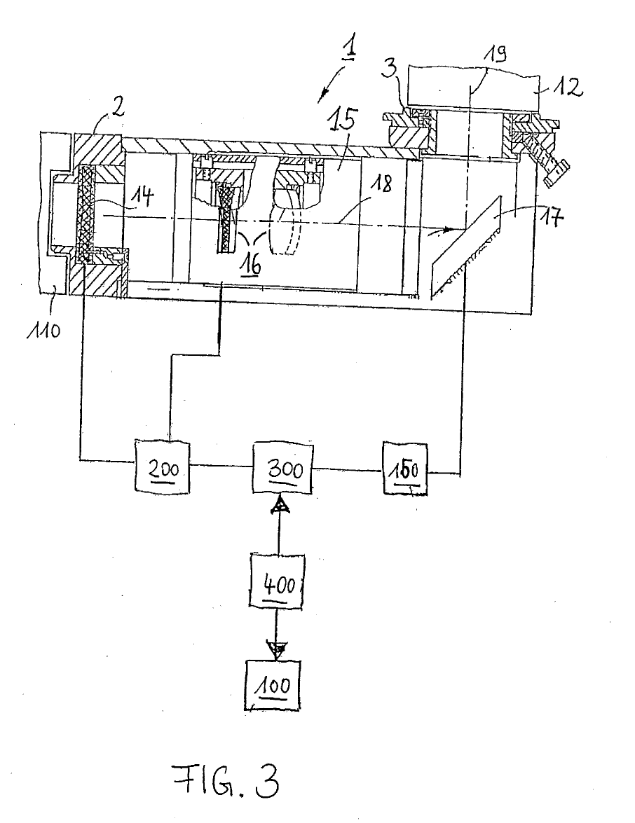

A video adapter which is technically less complex to realize, in accordance with FIG. 3, is proposed in order to avoid these disadvantages.

Identical reference numerals in FIGS. 2 and 3 designate identical elements. With regard to the basic principles of the video adapter 1 in accordance with FIG. 3, reference can be made to the explanation concerning FIG. 2. The video adapter in accordance with FIG. 3 has optical components 14 to 17, which are merely illustrated schematically and which each contain or constitute an SLM optical unit. For reasons of simplicity, FIG. 3 illustrates all four optical components 14 to 17 with an SLM optical unit, and it should expressly be pointed out that only at least one of the optical components has to have an SLM optical unit. (The rest of the components can then be as in FIG. 2 or else entirely omitted.) In order, however, not to have to illustrate all the permutations in separate figures, in the present case the simpler path was chosen of configuring all four components 14 to 17 mentioned as SLM optical units. The following explanations are given in this respect in detail:

The optical component 14 has an SLM optical unit, which can be, in particular, a transmissive microdisplay, in particular a transmissive LCD. Any desired diaphragm shape can thereby be set. Moreover, a transmissive microdisplay permits a setting of the transmissivity and also of the spectral intensity and, on account of different diaphragm shapes, also of the depth of field. The provision of an optical component 14 having an SLM optical unit thus makes it possible to realize more functions than with the conventional component 4 for exposure setting (cf. FIG. 2). Furthermore, a motor 30 for driving the optical component 4 (cf. FIG. 2) is superfluous since the driving of the component 14 can be effected purely electronically. Details concerning the electronic driving are explained further below.

The optical component 14 having an SLM optical unit can also be a transmissive microdisplay in the form of a liquid crystal lens. Such a liquid crystal lens permits the setting of different focal lengths. By means of suitable driving, this component can also be used for setting variable diaphragms. Finally, the already mentioned further functions of a transmissive microdisplay can be realized at least in part by means of corresponding driving. Consequently, the component 14 can in this case perform the functions of the traditional components 4, 5 and 6 (cf. FIG. 2).

The optical component 15 having an SLM optical unit is preferably in turn a transmissive microdisplay, in particular in the form of a liquid crystal lens. The focal length of this lens can be electronically set and adapted, such that a displacement in the direction of the axis 18 for focus setting can be obviated. Consequently, the corresponding motor 40 for the traditional optical component 5 (cf. FIG. 2) is superfluous.

The optical component 16 having an SLM optical unit is preferably a magnification or a zoom system, in which one or more lenses are replaced by a transmissive microdisplay, in particular in the form of a liquid crystal lens. This makes it possible to set the magnification without moving corresponding lens assemblies along the axis 18, with the result that the corresponding handles 46a, 46b in the traditional optical component 6 in accordance with FIG. 2 (or a motor-based driving system) can be obviated.

The optical component 17 having an SLM optical unit preferably constitutes a reflective microdisplay, such as a reflective LCD, or a micromirror array having individually driveable micromirrors which can be set in terms of their spatial orientation. A micromirror array is particularly preferred in this context since it can perform virtually all the functions of the traditional optical components of a video adapter: the individual micromirrors are (individually) adjustable/pivotable axes in the x and y directions (which lie in the basic plane of the array), with the result that a corresponding displacement of the object image in the image plane of the camera is possible. Since the driving of the micromirror array is effected purely electronically, the corresponding motors for driving the traditional optical component 7 (cf. explanations concerning FIG. 2) are superfluous. Furthermore, a micromirror array, by means of suitable aspherical or spherical or more generally non-planar orientation of the micromirrors, can additionally be used for focussing, but also for correcting imaging aberrations. Furthermore, by means of suitable orientation of the micromirrors, the micromirror array can be used for brightness setting. This is because, as already explained, the micromirror array can direct more or less arriving light in the direction of the image plane of the camera (in the direction of the axis 19). Since, finally, alteration of the focus is also associated with an alteration of magnification, the micromirror array 17 is also suitable in certain regions for setting the magnification and can thus replace the traditional optical component 6 (cf. FIG. 2).

The above explanations make it clear that when a micromirror array 17 is used, the functions of all the traditional optical components 4 to 7 in accordance with FIG. 2 can be performed by the micromirror array 17 at least in specific regions. Consequently, the micromirror array can in principle replace all the abovementioned traditional optical components 4 to 7, but also the optical components 14, 15 and 16 illustrated in FIG. 3.

As already explained above, with the use of a transmissive microdisplay having a focussing effect, the optical component 14 can replace the traditional optical components 4, 5 and possibly 6 and therefore also the optical components 15 and possibly 16. The same conversely holds true with the use of a transmissive microdisplay having a focussing and diaphragm effect as component 15, which can therefore replace the optical components 14 and possibly 16. An analogous consideration holds true in turn for the optical component 16. Separate pictorial illustrations of these different permutation possibilities have been dispensed with for reasons of simplicity (not in order to restrict the scope of protection).

FIG. 3 furthermore schematically illustrates the electronic driving systems: 200 designates the electronic driving system for the transmissive microdisplay or microdisplays in the optical components 14, 15 and 16. 150 designates the electronic driving system for the optical component 17. With the combined use of the components 17 and 14, 15 or 16, a combined electronic driving system 300 is provided. It is thereby possible, for example for exposure setting, for both a transmissive microdisplay and the micromirror array to be driven jointly in order to control/regulate the brightness depending on the dynamic range. The electronic driving system permits, in particular, a qualitatively better and delay-free joint driving of microscope 100 and video adapter 1 by means of the central control system 400. The central control system 400 makes it possible, for instance, to tap off the set zoom magnification at the microscope and to correspondingly drive that optical component 14 to 17 having an SLM optical unit which serves for exposure setting in the video adapter 1, in order to compensate for brightness alterations in this way.

The video adapter proposed according to the invention and the microscope system according to the invention thus open up a wealth of new possibilities for driving and regulating the video adapter and the common system comprising video adapter and microscope. The novel optical components proposed are able, moreover, to perform a plurality of functions of the corresponding traditional components of a video adapter and thus to replace one or more of said traditional optical components.

### LIST OF REFERENCE SYMBOLS

1, 1′, 1″ Video adapter

2, 2′, 2″ Connection for the microscope

3, 3′, 3″ Connection for the camera

4 Optical component for exposure setting

5 Optical component for focus setting

6 Optical component for magnification setting

7 Optical component for deflecting the beam path

10 Object

12 Camera

14 Optical component having SLM optical unit

15 Optical component having SLM optical unit

16 Optical component having SLM optical unit

17 Optical component having SLM optical unit

18 Axis

19 Axis

30 Motor for optical component 4

31 Shaft

32 Transmission

33 Lever

40 Motor for optical component 5

46a, 46b Handle

50 Motor for optical component 7

80 Microscope system

100 Microscope, stereomicroscope

101 Objective

102 Channel of the stereomicroscope

103 Channel of the stereomicroscope

104 Magnification changer

105 Magnification changer

106 Binocular tube

107 Beam splitter

108 Observation beam path

109 Observation beam path

110 Documentation port

111 Beam splitter

150 Electronic driving system for SLM-Optical unit

200 Electronic driving system for SLM-Optical unit

300 Combined electronic driving system

400 Central control system

What is claimed is:

1. Video adapter for a microscope, comprising:
a first connection for connecting the microscope;
a second connection for connecting a camera; and
at least one optical component for performing at least one of exposure setting, focus setting, magnification setting and deflection of at least one part of an observation beam path of the microscope into an image plane of the camera, wherein
the at least one optical component has an SLM optical unit.

2. The video adapter according to claim 1, wherein the SLM optical unit of the optical component is a reflective microdisplay.

3. The video adapter according to claim 2, wherein the reflective microdisplay is a reflective LCD.

4. The video adapter according to claim 1, wherein the SLM optical unit of the optical component is a micromirror array having individually driveable micromirrors that are adjustable in their spatial orientation.

5. The video adapter according to claim 1, wherein the SLM optical unit of the optical component is a transmissive microdisplay.

6. The video adapter according to claim 5, wherein the transmissive microdisplay is at least one of a transmissive LCD and a transmissive microdisplay in the form of a liquid crystal lens.

7. The video adapter according to claim 1, wherein the at least one SLM optical unit performs at least one of functions in the video adapter selected from a group consisting of: control of the brightness, spectral intensity, depth of field, focussing, magnification, beam deflection, beam splitting, and optical correction of the beam course.

8. The video adapter according to claim 1, wherein the SLM optical unit of the optical component has a micromirror array for at least one of beam deflection, focus setting and exposure setting.

9. The video adapter according to claim 1, wherein the SLM optical unit of the optical component has a reflective microdisplay for at least one of beam deflection and exposure setting.

10. The video adapter according to claim 1, wherein the SLM optical unit of the optical component has a transmissive microdisplay for at least one of focus setting, magnification setting and exposure setting.

11. A microscope system comprising:
a video adapter comprising:
a first connection for connecting the microscope;
a second connection for connecting a camera; and
at least one optical component for performing at least one of exposure setting, focus setting, magnification setting
and deflection of at least one part of an observation beam path of the microscope into an image plane of the camera,
wherein
the at least one optical component has an SLM optical unit; and
a microscope that can be connected to said video adapter.

12. The microscope system according to claim 11, further comprising a camera that can be connected to the video adapter.

13. The microscope system according to claim 11, wherein
the microscope is a stereomicroscope having an objective, magnification changers arranged in at least two of the channels of the stereomicroscope, an optional binocular tube, and a beam splitter for coupling out at least one part of the observation beam path to a documentation port of the stereomicroscope, said beam splitter being arranged in at least one of the channels, and
the first connection for the microscope connects to the documentation port of the stereomicroscope.

14. The microscope system according to claim 12, wherein
the microscope is a stereomicroscope having an objective, magnification changers arranged in at least two of the channels of the stereomicroscope, an optional binocular tube, and a beam splitter for coupling out at least one part of the observation beam path to a documentation port of the stereomicroscope, said beam splitter being arranged in at least one of the channels, and
the first connection for the microscope connects to the documentation port of the stereomicroscope.
